(19) United States
(12) Patent Application Publication
(10) Pub. No.: US 2010/0093587 A1
(43) Pub. Date: Apr. 15, 2010

(54) Detergent Composition and Method

(75) Inventors: Judith Preuschen, Ludwigshafen (DE); Claudia Schmaelzle, Ludwigshafen (DE); Dagmar Roth, Ludwigshafen (DE); Ralf Wiedemann, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: RECKITT BENCKISER N.V., HOOFDDORP (NL)

(21) Appl. No.: 12/441,577

(22) PCT Filed: Sep. 19, 2007
(86) PCT No.: PCT/GB2007/003559

§ 371 Date: Dec. 11, 2009

(30) Foreign Application Priority Data
Sep. 19, 2006 (GB) 0618402.2

(51) Int. Cl. C11D 3/20

(52) U.S. Cl. 510/194

(57) ABSTRACT

An automatic dishwashing machine cleaning composition for use during one or more wash and/or rinse cycle(s) of the dishwashing machine, the composition having an alkaline pH and comprising at least one non-starch carbohydrase which exhibits activity at a pH of 8 or above. A method of using said composition is also disclosed.

### TECHNICAL FIELD

This invention relates to a composition having machine-cleaning properties for use during the wash cycles of automatic dishwashing machines, and a method of using said composition.

### BACKGROUND AND PRIOR ART

Automatic dishwashing (ADW) machines commonly have a filter built in to capture soils. Typically these filters capture soils having a size of or greater than about 1 mm. Users should remove and clean the filter frequently in order to maintain the performance of the machine. However many do not do this and so the captured soil particles remain on the filter. Some soil particles will be washed away over time, but others will remain on the filter and decay, and can cause bad odours.

In addition to the formation of bad odours, soil particles may clog the filter. This may cause problems with the circulation of the wash and rinse waters leading to poor cleaning results including increased re-deposition of soils on the articles being washed in the dishwashing machine and on the, interior surfaces of the machine.

If the interior of the dishwashing machine e.g. the filter/pipes/plastic items are not cleaned frequently, the soils present may become harder to remove, further increasing the consumer's reluctance to do so. They may also become more malodorous, the performance of the automatic dishwashing machine may reduce significantly and/or the interior of the machine may become soiled.

This cleaning operation is ideally carried out without the need for additional wash and/or rinse cycles of the automatic dishwasher such as would be necessary if the machine cleaning operation was carried out by running a wash and/or rinse cycle in an empty machine. Accordingly, the compositions of the present invention are typically used in a wash and/or rinse cycles of the automatic dishwasher containing items, e.g. kitchenware, to be cleaned or rinsed.

It is well known in the art to use enzymes in compositions for washing wares inside an automatic dishwashing machine; see for example WO 98/39402.

It is an object of the present invention to address one or more of the above-mentioned problems.

### STATEMENT OF INVENTION

Surprisingly it has been found that when a non-starch carbohydrase is used in a composition having an alkalilne pH, and especially a pH of 8 or above, the composition can be used in one or more wash and/or rinse cycle(s) of an automatic dishwashing machine to provide a cleaning effect to the interior of that machine.

According to a first aspect of the present invention, there is provided an automatic dishwashing machine cleaning composition for use during one or more wash and/or rinse cycle(s) of the dishwashing machine, the composition having an alkaline pH and comprising at least one non-starch carbohydrase which exhibits activity at a pH of 8 or above.

Thus, in accordance with the present invention the compositions of the first aspect of the invention are used in one or more wash and/or rinse cycles of an automatic. dishwashing machine to remove soils from the interior of the machine e.g. from the pipes, filter and plastic items.

According to the second aspect of the present invention, there is provided a method of treating the interior of an automatic dishwashing machine to prevent or remove the build-up of soils, the method comprising applying the composition of the first aspect to the interior of the machine during one or more wash or rinse cycle(s) of the dishwasher.

It is preferred according to the present invention that the dishwasher is at least partially loaded with articles to be cleaned, e.g. kitchenware, when the method is carried out. It is also preferred that the compositions of the invention are used over two or more sequential operations of the dishwashing machine, preferably three or more, such as four or more. The composition may be used on a regular basis, such as weekly or once or twice a month etc. Alternatively the compositions may be used in the majority of operations of the dishwashing machine.

According to a third aspect of the present invention, there is provided the use, during one or more wash and/or rinse cycles in an automatic dishwashing machine, of a alkaline composition comprising a non-starch carbohydrase which exhibits activity at a pH of 8 or above to degrade soils on the interior surfaces of that machine.

In particular, interior surfaces include the filter, pipes and plastic items found in the interior of the dishwashing machine. Preferably there is provided the use, during two or more wash and/or rinse cycles in an automatic dishwashing machine, of a composition comprising a non-starch carbohydrase to degrade soils on the interior surfaces of that machine.

The compositions of the invention are intended to degrade tough soils, especially fibrous soils, which may otherwise be difficult to remove from the interior of the dishwashing machine, e.g. from the pipes, filter and plastic items. This allows the compositions of the invention to be used to either remove or reduce existing build-up of soils in the interior of the machine, or, to prevent build-up when used regularly in the wash and/or rinse cycle.

Soils which can be broken down by the composition of the invention include fibrous (plant cell wall containing) soils such as those from cereals (including oat flakes) and cereal products (e.g. full-grain bread), fruits and vegetables. Some specific examples include vegetable pieces and fibres such as lettuce, asparagus, spinach etc and fruits pieces and fibres such as fruit peels e.g. orange and lemon peels, apple, strawberry or rose-hip pieces and fibres from fruit juices. Once degraded the soils may pass easily through the filter and be washed away.

The compositions of the invention are used to remove soils from the interior of the dishwashing machine, especially from the filter, pipes and/or plastic items. This removal may be of soils which have built up over a period of time in the interior of the dishwashing machine especially in the aforementioned areas. Alternatively, the compositions of the invention may be used to prevent the build-up of soils. According to this embodiment, the compositions are used to remove soils introduced into the machine in the dishwashing cycle in which the compositions are used. These two modes of action provide a machine maintenance effect.

The compositions of the invention are typically applied to the soils to be removed by introducing the compositions into the dispensing means (built-in or self standing) of the dishwashing machine and subsequently being released into the interior cavity of the machine during a wash or rinse cycle. Alternatively the compositions may be added directly into the interior cavity of the dishwashing machine. In both cases it is the action of the wash/rinse water which distributes the composition through the interior cavity and thus applies it to the soils to be removed. Accordingly, the compositions may be applied to the soils in a form which has been diluted with the wash/rinse water.

The term ‘non-starch carbohydrase which exhibits activity at a pH of 8 or above’ means a non-starch carbohydrase which exhibits at least some enzymatic activity on one or more of its substrates at a pH of 8 or more, preferably at least 5% of the maximum activity exhibited at its optimal pH range, more preferably at least 8%, most preferably at least 10%.

The term ‘sequential operations’ as used herein means that two operations of the dishwashing machine are run following each other. There may be a time separation between the two operations but there are no intervening operations. Where the term ‘operations’ is used, this refers to the usual full dishwashing operation which comprises an optional pre-wash cycle, a wash cycle plus a rinse cycle unless the context requires only a wash or a rinse cycle. If the latter is the case than an ‘operation’ means in that context only a wash or a rinse cycle (including pre-wash).

Percentage definitions are given below. In this specification a reference to the percentage amount of the defined component is to its percentage by weight on the total weight of the composition, unless otherwise stated.

References in this specification to a component, for example a non-starch carbohydrase, embrace the possibility that there may be only one such component present, or more than one. When a percentage value is stated for a component in a general definition given herein, including in any claim, that value denotes the total amount present, when more than one such component is present. For example when we state that there may suitably be present at least 0.01% wt of a non-starch carbohydrase active enzyme, this figure denotes the total amount of non-starch carbohydrase active enzymes present, when there is more than one; unless otherwise stated.

### DETAILED DESCRIPTION

The present invention will now be described in further detail.

The compositions of the present invention are suitable for use on all parts of the interior of an automatic dishwasher which may become adversely affected by soils and the build-up thereof. It has been noted that filters, pipes and plastic items in the dishwasher are especially susceptible to this problem.

a) Form of the Compositions

The detergent compositions of the present invention may be of any suitable form, including paste, liquid, solid (such as tablets, powder/granules), foam or gel, with powders and tablets being preferred. The composition may be in the form of a unit dose product, i.e. a form which is designed to be used as a single portion of detergent composition in a washing operation. Of course, one or more of such single portions may be used in a cleaning operation.

Solid forms include, for example, in the form of a tablet, rod, ball or lozenge. The composition may be a particulate form, loose or pressed to shape or may be formed by injection moulding or by casting or by extrusion. The composition may be encased in a water soluble wrapping, for, example of PVOH or a cellulosic material. The solid product may be provided as a portioned product as desired.

The composition may also be in paste, gel or liquid form, including unit dose (portioned products) products. Examples include a paste, gel or liquid product at least partially surrounded by, and preferably substantially enclosed in a water-soluble coating, such as a polyvinyl alcohol package. This package may for instance take the form of a capsule, a pouch or a moulded casing (such as an injection moulded casing) etc. Preferably the composition is substantially surrounded by such a package, most preferably totally surrounded by such a package. Any such package may contain one or more product formats as referred to herein and the package may contain one or more compartments as desired, for example two, three or four compartments.

If the composition is a foam, a liquid or a gel it is preferably an aqueous composition although any suitable solvent may be used. According to an especially preferred embodiment of the present invention the composition is in the form of a tablet, most especially a tablet made from compressed particulate material.

If the compositions are in the form of a viscous liquid or gel they preferably have a viscosity of at least 50 mPas when measured with a Brookfield RV Viscometer at 25° C. with Spindle 1 at 30 rpm.

The compositions of the invention may be made by any suitable method depending upon their format. Suitable manufacturing methods for detergent compositions are well known in the art and do not require further explanation here. For example, detergent tablets may be made by compacting granular/particular material.

The compositions of the invention will typically be used by placing them in a detergent dispenser e.g. in a dishwasher machine draw or free standing dispensing device in an automatic dishwashing machine. However, if the composition is in the form of a foam, liquid or gel then it may be applied to by any additional suitable means into the dishwashing machine, for example by a trigger spray, squeeze bottle or an aerosol.

The compositions of the invention may be formulated as either an additive product to be used in addition to the normal dishwashing detergent product, or it may be formulated as a dishwashing detergent product per se.

b) Non-Starch Carbohydrase Active Enzyme(s)

The compositions of the invention comprise one or more non-starch carbohydrase active enzyme(s) which exhibit(s) activity at a pH of 8 or above, preferably at a pH of 9 or above.

It is especially preferred that the compositions of the invention comprise a cellulase, hemicellulase, pectinase or lactase enzyme as the non-starch carbohydrase(s) which exhibit(s) activity at a pH of 8 or above. Mixtures of these enzymes may also be used when two or more non-starch carbohydrases are to be used.

Non-starch carbohydrases are enzymes not exhibiting amylase activity. They are classified into four main classes although other minor sub-classes exist:

1) cellulases, 2) hemi-cellulases and 3) pectinases and 4) lactases. According to the present invention enzymes of any one of these sub-classifications may be used.

Cellulases are active on β-1,4-Glucose units found in cellulose. Suitable examples having activity in alkaline pHs can be chosen from Endo-β-1,4-Glucanase, Exo-β-1,4-Glucanase, and cellobiase.

Hemicelluloses are cellulose-like carbohydrates, but with differing chemical composition, e.g. 5-ring sugars. Hemi-cellulases hydrolyse glycosidic linkages in hemicellulose. Suitable examples having activity in alkaline pHs can be chosen from hemicellulases, hexosanases and pentosanases (e.g. xylanases).

Pectinases degrade pectin, which comprises predominantly homopolymeric 1,4-β-D galacturonic acid. Suitable examples having activity in alkaline pHs can be chosen from pectinases, pectin-esterases, pectate-lyases, pectin lyases and polygalacturonases. Examples of pectate lyases active at pH 8 and above and which are thus suitable for use according to the present invention are described in US-A-2006/0165613.

Suitable non-starch carbohydrase(s) which exhibit at least some activity at pH 8 and above and which are suitable for use in the present invention include those sold under the trade marks Celluzyme 0.7T, Carezyme 4500 T, Carezyme 4500L, Novozym 342 (are ex Novozymes A/S), IndiAge Neutra G, Multifect CEG, IndiAge MAX G, GC 220, GC 880, Primafast 200, Multifect Xylanase, Multifect 720 and IndiAge RFW (ex Genencor International).

Surprisingly we have found that the cellulase Multifect CEG and certain pectate lyases as described in US-A-2006/0165613 may advantageously be used in combination according to the present invention. Thus in preferred embodiments the composition comprises both Multifect CEG and pectate lyases as these have been found to be especially effective at the alkaline pHs typically encountered in detergent compositions for automatic dishwashing products.

Preferably the compositions comprise at least 0.01 wt % of non-starch carbohydrase active enzyme. Preferably it contains at least 0.05 wt %, more preferably 0.1 wt % active enzyme, most preferably at least 0.3 wt % active enzyme, such as at least 0.5 wt % of non-starch carbohydrase active enzyme. Preferably the composition comprises up to 10 wt % non-starch carbohydrase active enzyme(s), preferably up to 5 wt %, more preferably up to 2.5 wt % and most preferably up to 2 wt %, such as up to 1.5 wt %, or even up to 1 wt %. It is most preferred that the compositions comprise 0.1 to 2 wt % of the non-starch carbohydrase active enzyme(s).

A preferred composition contains at least two non-starch carbohydrases.

When first and second non-starch carbohydrase(s) are present, the composition preferably comprises at least 0.01 wt %, preferably at least 0.1 wt %, more preferably at least 0.3 wt % and most preferably at least 0.5 wt % of the first non-starch carbohydrase; and at least 0.01 wt %, more, preferably at least 0.1 wt %, more preferably at least 0.3 wt % and most preferably at least 0.5 wt % of the second non-starch carbohydrase.

The enzymes can be used in any suitable form in the compositions of the invention, for example, as an aqueous solution or as a dispersion in foam, gel, liquid or solid compositions or as a granule or other particulate form in solid compositions such as powder or tablet compositions.

According to one embodiment of the invention, the non-starch carbohydrase(s) may be used in a form whereby they have been treated with a material to retard their dissolution in the wash and/rinse water of the dishwashing machine. This has the advantage of providing for at least a proportion of the enzyme to remain in the dishwasher, and especially in the filter, for more than one wash and/or rinse cycle thus improving the efficacy of the method. According to this embodiment the enzymes are therefore preferably used in a granulated form and/or coated with a material to retard the dissolution of the enzyme (in whatever form they are used). Any suitable coating material may be used which retards the dissolution of the enzyme into the wash/rinse water, such as polymers e.g. polyvinyl alcohol, a copolymer of PVA and vinyl acetate, polyvinylpyrrolidone and copolymers thereof such as PVP-vinyl acetate (Luvitec VA 64 ex BASF).

c) pH of the Composition

The compositions of the invention have an alkaline pH which means that they have a pH of greater than 7. The pH values referred to herein are those obtained when the composition is diluted 1:100 in deionised water at 20° C.

Preferably the pH of the composition is 8 or more, more preferably 8.5 or more, especially 9 or more, such as 10 or more. Preferably the pH is 12.5 or less, more preferably 12 or less, such as 11.5 or less. The pH of the composition will depend upon many factors such as the format thereof.

The pH of the composition may be brought into the ranges mentioned hereinabove by the addition of one or more acids or bases (for example sodium (bi)carbonate or sodium sulphate) depending upon the pH of the unadjusted composition.

Where the compositions of the invention comprise one or more acids to adjust the pH to within the above mentioned range, the acid(s) preferably comprise(s) an organic acid, more preferably a polycarboxylic acid, preferably having 1 to 5 carbon atoms and most preferably citric acid.

The acid or base, if used, is present in an amount sufficient to maintain the pH of the composition within the desired range. The amount used will depend upon the pH of the unadjusted composition and the type of acid or base used.

d) Optional Ingredients

According to one preferred embodiment of the invention the compositions may, in addition to the one or more non-starch carbohydrases, also comprise one or more enzymes from the group of ligninase and cutinase enzymes. Conventional amounts of these additional enzymes may be used, preferably 0.01 to 5 wt % active enzyme, more preferred 0.05 to 2 wt % active enzyme, most preferred 0.1 to 1 wt % of active enzyme. These enzymes act on certain material present in cell walls such as lignin and cutin and thus they enhance/support the action of the one or more non-starch carbohydrases to degrade the well wall material present in fibrous soils.

A preferred optional ingredient in the compositions of the present invention is surfactant. The compositions preferably comprise up to 10 wt % surfactant, preferably up to 7.5 wt %, more preferably up to 5 wt %. When surfactant is present the compositions preferably comprise an amount of 0.1 wt % or more, more preferably 0.2 wt % or more. A surfactant is most preferably present in an amount of 0.1 to 4 wt % surfactant, such as 0.2 to 3.5 wt %, such as 0.5 to 3 wt %.

Suitable surfactants include anionic, non-ionic, cationic or amphoteric surfactants, or mixtures thereof. Many such surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred. Non-ionic surfactants are especially preferred.

One possible class of nonionic surfactants is ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

According to one preferred embodiment of the invention, the non-ionic surfactants additionally comprise propylene oxide units in the molecule. Preferably these PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]_{X}[CH₂CH₂O]_{Y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different nonionic surfactants is suitable in the context of the present invention for instances mixtures of alkoxylated alcohols and hydroxy group containing alkoxylated alcohols.

The detergent compositions of the invention may comprise a bleaching compound. Any type of bleaching compound conventionally used in detergent compositions may be used according to the present invention. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

Desirably if the bleaching compound is used, it is present in an amount of from 1 to 30 wt %, especially 5 to 25 wt %, most preferably 10 to 20% wt based on the total weight of the composition.

If the compositions of the invention comprise a bleach they also preferably comprise one or more bleach activators and or one or more bleach catalysts. Any suitable bleach activator may be included for example TAED. Any suitable bleach catalyst may be included. Conventional amounts of both the bleach catalyst and bleach activator may be used e.g. independently for both the bleach activator and bleach catalyst, amounts of from 0.01 to 10 wt %, more preferred of from 0.1 to 8 wt % and most preferred of from 0.5 to 5 wt % based on the weight of the total composition.

The detergent compositions may also comprise conventional amounts of detergent builders which may be either phosphorous based or non-phosphorous based, or even a combination of both types. Suitable builders are well known in the art.

If phosphorous builders are to be used in the compositions of the invention then it is preferred that phosphonates, mono-phosphates, di-phosphates, tri-polyphosphates or oligomeric-poylphosphates are used. The alkali metal salts of these compounds are preferred, in particular the sodium salts. An especially preferred builder is sodium tripolyphosphate (STPP).

The non-phosphorous based builder may be organic molecules with carboxylic group(s), amino acid based compound or a succinate based compound. The term ‘succinate based compound’ and ‘succinic acid based compound’ are used interchangeably herein.

Builder compounds which are organic molecules containing carboxylic groups include citric acid, fumaric acid, tartaric acid, maleic acid, malic acid, lactic acid and salts thereof. In particular the alkali or alkaline earth metal salts of these organic compounds may be used, and especially the sodium salts. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid and salts and derivatives thereof). GLDA (salts and derivatives thereof) is especially preferred according to the invention, with the tetrasodium salt thereof being especially preferred. Other suitable builders are described in U.S. Pat. No. 6,426,229 which is incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

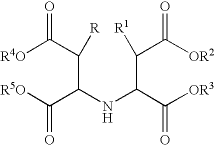

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms. A preferred example is tetrasodium imminosuccinate.

Preferably the total amount of builder present in the compositions is an amount of at least 5 wt %, preferably at least 10 wt %, more preferably at least 20 wt %, and most preferably at least 25 wt %, preferably in an amount of up to 70 wt %, preferably up to 65 wt %, more preferably up to 60 wt %, and most preferably up to 35 wt %. The actual amount

The detergent compositions of the invention may further comprise a secondary builder (or cobuilder). Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred.

Suitable polycarboxylic acids are acyclic, alicyclic, heterocyclic and aromatic carboxylic acids, in which case they contain at least two carboxyl groups which are in each case separated from one another by, preferably, no more than two carbon atoms.

Polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid. Another suitable polycarboxylic acid is the homopolymer of acrylic acid. Other suitable builders are disclosed in WO 95/01416, to the contents of which express reference is hereby made.

Polymers intended to improve the cleaning performance of the compositions may also be included therein and these are an especially preferred option ingredient of the compositions of the invention. For example, sulphonated polymers may be used and these are especially preferred for inclusion in the compositions of the present invention as they have been found to be compatible with enzymes. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof. Suitable sulfonated polymers are also described in U.S. Pat. No. 5,308,532 and in WO 2005/090541.

When a sulfonated polymer is present, it is preferably present in the composition in an amount of at least 0.1 wt %, preferably at least 0.5 wt %, more preferably at least 1 wt %, and most preferably at least 3 wt %, up to 40 wt %, preferably up to 25 wt %, more preferably up to 15 wt %, and most preferably up to 10 wt %.

It is especially preferred according to the present invention that the composition further comprises at least one of a surfactant, a detergency builder and/or a sulphonated polymer, preferably two of these optional ingredients and more preferably all three.

The compositions of the invention may further comprise a source of multivalent ions for technical and/or performance reasons. For example, multivalent ions and especially zinc and/or manganese ions may be included for their ability to inhibit corrosion on metal and/or glass. Bismuth ions may also have benefits when included in such compositions.

For example, organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄ K₂TiF₆, K₂ZrF₆, CoSO₄, Co(NO₃)₂ and Ce(NO₃)₃. Zinc salts are specially preferred corrosion inhibitors.

Therefore, an especially preferred optional ingredient according to the present invention is a source of multivalent ions such as those mentioned in the immediately preceding paragraphs and in particular zinc, bismuth and/or manganese ions. In particular a source of zinc ions is preferred. Any suitable source of multivalent ions may be used, with the source preferably being chosen from sulphates, carbonates, acetates, gluconates and metal-protein compounds and those mentioned in the immediately preceding paragraphs.

Any conventional amount of multivalent ions/multivalent ions source may be included in the compositions of the invention. However, it is preferred that the multivalent ions are present in an amount of from 0.01% wt to 5% wt, preferably 0.1% wt to 3% wt, such as 0.5% wt to 2.5% wt. The amount of multivalent ion source in the compositions of the invention will thus be correspondingly higher.

The detergent composition according to the invention may also comprise one or more foam control agents. Suitable foam control agents for this purpose are all those conventionally used in this field, such as, for example, silicones and paraffin oil. The foam control agents are preferably present in the composition in amounts of 5% by weight or less of the total weight of the composition.

The foam, liquid or gel form compositions preferably comprise a viscosity modifier, e.g., a thickener which increases the viscosity of the composition. Preferably a viscosity modifier is present in an amount of at least 0.1 wt %, preferably at least 0.2 wt %. Preferably the composition comprises up to 3 wt % of a viscosity modifier, more preferably up to 2 wt %.

Exemplary viscosity modifiers include polycarboxylate polymers, polyacrylamides, clays, and mixtures thereof.

When the composition is in a foam, liquid or gel form, it preferably comprises at least 40 wt % water, preferably at least 50 wt %, more preferably at least 70 wt % and most preferably at least 90 wt % such as at least 95 wt % water.

Preferably the compositions comprise one or more fragrances, suitably in an amount of at least 0.01 wt %, preferably at least 0.05 wt %, thereof; suitably up to 1 wt %, preferably up to 0.3 wt %.

The compositions may include a preservative. Exemplary preservatives which may form part of the compositions of the invention include useful water soluble or water dispersible compositions which include terpenes and parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof.

The composition may include further anti-microbially effective agents, e.g., pyrithiones (especially zinc pyrithione which is also known as ZPT), dimethyldimethylol hydantoin (Glydant), methylchloroisothiazolinone/methylisothiazolinone (Kathon CG), sodium sulphite, sodium bisulphite, imidazolidinyl urea (Germall 115), diazolidinyl urea (Germaill II), benzyl alcohol, 2-bromo-2-nitropropane-1,3-diol (Bronopol), formalin (formaldehyde), iodopropenyl butylcarbamate (Polyphase P100), chloroacetamide, methanamine, methyldibromonitrile glutaronitrile (1,2-dibromo-2,4-dicyanobutane or Tektamer), glutaraldehyde, 5-bromo-5-nitro-1,3-dioxane (Bronidox), phenethyl alcohol, o-phenylphenol/sodium o-phenylphenol, sodium hydroxymethylglycinate (Suttocide A), polymethoxy bicyclic oxazolidine (Nuosept C), dimethoxane, thimersal dichlorobenzyl alcohol, captan, chlorphenenesin, dichlorophene, chlorbutanol, glyceryl laurate, halogenated diphenyl ethers like 2,4,4-trichloro-2-hydroxy-diphenyl ether (Triclosan or TCS), 2,2-dihydroxy-5,5-dibromo-diphenyl ether, phenolic anti-microbial compounds like phenol, phenols substituted by C₁₋₈ alkyls group(s) and/or by halogen atom(s) and/or by benzyl group(s), resorcinol and its derivatives, 5-chloro 2,4-dihydroxydiphenyl methane, 4-chloro 2,4-dihydroxydiphenyl methane, 5-bromo 2,4-dihydroxydiphenyl methane, and 4-bromo 2,4-dihydroxydiphenyl methane, bisphenolic compounds like 2,2-methylene bis(4-chlorophenol), 2,2-methylene bis (3,4,6-trichlorophenol), 2,2-methylene bis (4-chloro-6-bromophenol), bis(2-hydroxy-3,5-dichlorophenyl)sulphide, and bis(2-hydroxy-5-chlorobenzyl)sulphide, benzoic esters (parabens) like methylparaben, propylparaben, butylparaben, ethylparaben, isopropylparaben, isobutylparaben, benzylparaben, sodium methylparaben, and sodium propylparaben, halogenated carbanilides (e.g., 3,4,4-trichlorocarbanilides (Triclocarban or TCC), 3-trifluoromethyl-4,4-dichlorocarbanilide or 3,3,4-trichlorocarbanilide.

If the composition is in the form of a shaped body or a tablet then a conventional amount of a binder material may be included. Any conventional binders may be used, typically in an amount of up to 10% wt, more preferably in an amount of up to 5% wt. Suitable binders include polyethylene glycols.

The composition may comprise other optional excipients for example dyes, stabilizers, and further enzymes. Suitably dyes may include food grade dyes such as Ultramarin Blue, Patentblau and Sanolin Blue EHRL ex Clariant GmbH.

Further enzymes may be present, which may be selected from, for example, lipases, proteases and amylases. Such further enzymes may suitably be present in an amount from 0.01 to 5 wt %, preferably 0.05 to 2 wt %.

Unless specific amounts are stated for the optional ingredients described herein, conventional amounts may be used in the compositions of the invention.

e) Method of Treatment

The method of the invention may be carried out during the wash and/or rinse cycle(s) of an empty (i.e. not loaded with items to be cleaned) dishwasher. However, it is preferred that the dishwasher is at least partially loaded with articles, e.g. kitchenware, when then method is carried out as this avoids the need to run additional cycles of the dishwasher only for the purpose of cleaning it.

It is also preferred that the compositions of the invention are used over two or more operations of the dishwashing machine, preferably as a part of the normal usage of thereof. It is preferred that these operations are sequential operations. The dishwashing operation may comprise a pre-wash (optional), a wash cycle and a rinse cycle or may comprise either a wash-only cycle or a rinse-only cycle. This rinse-only cycle may be either a pre-wash cycle or a post-wash cycle. The use of the compositions of the invention in only a wash cycle, or, only a rinse cycle may be achieved by either dosing the composition into the automatic dishwashing machine which is then run on only that type of cycle with the composition present. Alternatively, the compositions may be formulated with a suitable release mechanism e.g. accelerated or delayed release so that the one or more none-starch carbohydrases are released at the desired part of the dishwashing operation. Where a polymer is to be used to achieve an accelerated or delayed release of the composition of the invention, suitable polymers to achieve this effect are well known in the art.

The dishwashing machine may be run on any of its programmes during the method including both wash and/or rinse programmes. However, it is preferred that during the method of the invention at least one wash cycle is performed, preferably at a temperature of 50° C. or above. Typically a wash and rinse cycle may last up to 2 hours, with a wash-only cycle lasting up to 1.5 hours and a rinse-only cycle lasting up to 0.5 hours.

It is preferred that the composition of the invention is in contact with the soil to be removed for a period of at least 10 minutes, preferably at least 15 minutes, such as at least 20 minutes regardless of whether the composition is applied to the soils during the wash or rinse cycle.

The method of the invention is preferably performed by adding the composition of the invention into the built-in detergent dispenser of the dishwashing machine so that the composition is released into the interior of the machine during normal operation thereof. Alternatively, the compositions may be added to a non-built in dispensing device or even added directly into the cavity of the machine interior.

During the wash/rinse cycle(s) the composition is distributed throughout the cavity of the dishwashing machine interior by the spray mechanism. This provides contact with the surfaces of the interior of the machine e.g. the pipes, filter and plastic items. Additionally the water containing the composition of the invention must drain through the filter therefore providing additional opportunities for removal of soils therefrom.

The invention will now be further described by way of the following non-limiting example. Further modifications will be obvious to the person skilled in the art.

### Examples

### Example 1

### Compositions According to the Invention

Granulated detergent compositions of the formulations given in the table below may be used in an automatic dishwashing machine to remove, or prevent, the build-up of soils on the interior of the machine. All percentages are by weight based on the weight of the total composition.

Composition A is a phosphate-free composition, composition B is a reduced phosphate composition and composition C is a phosphate based composition. All figures are expressed as parts by weight.

| Ingredient | A | B | C |
|---|---|---|---|
| Sodium Tri- | 0.0 | 24.0 | 50.0 |
| polyphosphate | | | |
| Sodium citrate | 50.0 | 26.0 | 0.0 |
| Sodium carbonate | 10.0 | 10.0 | 10.0 |
| sodium | 12.0 | 12.0 | 12.0 |
| percarbonate | | | |
| TAED | 3.0 | 3.0 | 3.0 |
| Protease | 1.0 | 1.0 | 1.0 |
| Amylase | 0.5 | 0.5 | 0.5 |
| Cellulase | 1.0 | 1.0 | 1.0 |
| C₁₆₋₁₈ 5EO | 1.0 | 1.0 | 1.0 |
| Polyethyleneglycol | 10.0 | 10.0 | 10.0 |
| 1500 | | | |
| Benzotriazole | 0.1 | 0.1 | 0.1 |
| Perfume | 0.1 | 0.1 | 0.1 |
| Sodium sulphate or | | | |
| additional sodium | | | |
| carbonate as | | | |
| needed | | | |

The compositions are prepared by mixing the ingredients together in a conventional industrial powder mixer. Sufficient sodium sulphate or soda ash is added so that the pH of the composition is 10 for a 1 wt % aqueous solution at room temperature.

The compositions can be used in a granulated powder form or the powder can be compressed to form a tablet and used in tabletted form. The compositions can be used to remove, or prevent, the build up of soils in the interior of an automatic dishwashing machine. Such compositions can be used during the wash cycle of the dishwashing machine.

1. An automatic dishwashing machine cleaning composition adapted to be used during a wash cycle or a rinse cycle of the dishwashing machine, the composition having an alkaline pH and comprising at least one non-starch carbohydrase which exhibits activity at a pH of 8 or above.

2. A composition according to claim 1, which comprises at least two non-starch carbohydrases.

3. A composition according to claim 1, wherein the at least one non-starch carbohydrase exhibits activity at a pH of 9 or above.

4. A composition according to claim 1, wherein the composition comprises 0.05 to 5 wt % of the at least one non-starch carbohydrase.

5. A composition according to claim 1, wherein the at least one non-starch carbohydrase comprises a cellulase, hemicellulase, pectinase or lactase.

6. A composition according to claim 1, which yields a solution of pH of 8 or more when diluted 1:100 in deionised water at 20° C.

7. A composition according to claim 6, which yields a solution of pH of 9.5 or more.

8. A composition according to claim 6, which yields a solution of pH of up to 11.5.

9. A composition according to claim 1 in the form of solid, liquid, foam, paste or gel.

10. A composition according to claim 9, wherein the composition is substantially enclosed in a water soluble coating.

11. A composition according to claim 1, wherein the composition further comprises at least one or more of: a surfactant, a detergency builder and a sulphonated polymer.

12. A composition according to claim 1, wherein the composition further comprises one or more enzymes from the group of ligninases and cutinases.

13. A method of treating the interior of an automatic dishwashing machine to prevent or remove the build-up of soils, the method comprising the step of: supplying a composition according to claim 1 to the interior of the machine during at least one wash cycle or at least one rinse cycle of the dishwashing machine.

14. A method as claimed in claim 13, wherein the dishwasher is at least partially loaded with articles during the at least one wash cycle or at least one rinse cycle.

15. A method according to claim 13, wherein the compositions are used over two or more sequential wash cycles or rinse cycles of the dishwashing machine.

16. A method of degrading soils on an interior surface of an automatic dishwashing machine, which method comprises the steps of: providing a composition comprising a non-starch carbohydrase which exhibits activity at a pH of 8 or above during at least one or more wash cycles or one or more rinse cycles of the automatic dishwashing machine.
